(19) United States
(12) Patent Application Publication
(10) Pub. No.: US 2023/0272899 A1
(43) Pub. Date: Aug. 31, 2023

(54) SMALL APERTURE LOW-BEAM AND HIGH-BEAM SYSTEM AND METHODS

(71) Applicant: J.W. SPEAKER CORPORATION, Germantown, WI (US)

(72) Inventor: Bradley William Kay, Mequon, WI (US)

(21) Appl. No.: 18/113,226

(22) Filed: Feb. 23, 2023

Related U.S. Application Data
(60) Provisional application No. 63/314,560, filed on Feb. 28, 2022.

(51) Int. Cl. F21V 5/00; F21S 41/25; F21S 41/36

(52) U.S. Cl. CPC F21V 5/007; F21S 41/25; F21S 41/36

(57) ABSTRACT

A vehicular illumination system structured as an array of optical trains in each of which the element of a light-concentrating optical sub-system and the element of the projection optical sub-system are uniquely spatially mapped one into another to ensure that light from a given optical source of the employed arrays of optical sources necessarily interacts both with a dedicated, spatially-distinct light concentrator of the corresponding optical train and with a dedicated, spatially-distinct projection optical component while not interacting with either the light concentrator or the projection optical component of the neighboring optical train. Embodiments ensure freedom of change of the overall shape of the system while, in operation, forming light distribution in pre-determined illumination plane that is substantially devoid of visually-perceived color aberrations.

### CROSS-REFERENCE TO RELATED APPLICATIONS

This patent application claims priority from and benefit of the U.S. Provisional Patent Application No. 63/314,560 filed on Feb. 28, 2022. This patent application is also a continuation from the international patent application No. PCT/US2023/013667 filed on Feb. 23, 2023. The disclosure of each of the above-identified patent applications is incorporated by reference herein.

### TECHNICAL FIELD

The present invention relates to illumination systems employed in vehicular systems, and in particular to vehicular illumination systems characterized by a small volume factor, and/or extremely small aperture and configured for use, in a specific example, as low-beam-high-beam illumination systems.

### RELATED ART

Various implementations of vehicular illumination systems of related art, and, in particular, those configured as headlights or headlamps including those configured according to a matrix approach—appear to be designed around a concept of utilizing a structure in which either light from multiplicity of light sources is projected towards the target illumination plane through a smaller number of projection lenses (in fact, often only one, single projection lens) or light from a smaller number of light sources is delivered to the illumination plane through a matrix or array of the exceedingly-high (in comparison) number of projection lenses or lenslets. While under some opto-geometrical conditions such configurations may arguably provide a more uniformly lit target illumination plane, the practical shortcomings of such implementations can be well defined. For example, projecting light from multiple light sources towards the illumination plane through projections lenses the number of which is smaller than the number of the sources (and, in a rather common situation—through a single projection lens) often leads not only to the unnecessarily increased transverse size of the overall illumination assembly (which is dictated by the size of such projection lens that has to be sufficiently large to maximize light throughput) but also to residual chromatic aberrations manifesting in visually-perceivable distribution of color across the target illumination plane.

### SUMMARY OF THE INVENTION

Embodiments of the present invention provide a vehicular illumination system that includes an array of optical trains (containing at least a first optical train and a second optical train, each of which has a respectively-corresponding optical axis). Each of the constituent optical trains includes a corresponding first optical system, a corresponding second optical system, and a corresponding third optical system. The first optical system is configured to form a first beam of light (the source of which may be positioned at a pre-determined object location in front of the first optical system), and to define—for such object location—a respectively-corresponding plane of convergence of light collected, in the form of the first beam, from the source of light when such source of light is placed at the object location. The second optical system is positioned or disposed to have its back focal plane substantially coincide with the plane of convergence of the first optical system, to receive the first beam of light from the first optical system, and to form a respectively-corresponding second beam of light that has a first degree of convergence in a first plane containing the optical axis and a second degree of convergence in a second plane containing the optical axis and transverse to the first plane. The third optical system is configured to transmit light from the second beam of light therethrough to form a respectively-corresponding third beam of light that has a third degree of convergence in the first plane, the third degree being different from the first degree. In at least one implementation, the embodiment is configured to satisfy at least one of the following conditions: the first degree of convergence and the second degree of convergence are substantially equal to one another; and the first degree of convergence and/or the second degree of convergence are substantially zero. Alternatively or in addition, substantially each of the embodiment may be configured to satisfy at least one of the following conditions: (i) a first optical system of the first optical train is configured to form the respectively-corresponding first beam of light with such distribution of light in the respectively-corresponding plane of convergence that is necessarily not optically-conjugate to that at the respectively-corresponding object location; and (ii) a first optical system of the second optical train is configured to form the respectively-corresponding first beam of light with such distribution of light in the respectively-corresponding plane of convergence that is substantially optically-conjugate to that at the respectively-corresponding object location. Practically every embodiment may additionally include, in at least one of the first and second optical trains, an optical aperture formed in the respectively-corresponding plane of convergence and dimensioned such as to have a light distribution, generated by the at least one of the first and second optical trains, substantially not have luminous intensity above a horizon plane (at least at and after the last surface of the embodiment, upon the propagation of light from the third optical system towards the target illumination plane). Alternatively or in addition, substantially in every embodiment, a portion of at least one optical train of the array of optical trains that is axially limited by a respectively-corresponding first optical system and a respectively-corresponding second optical system may be configured as a single block of substantially optically uniform and optically transparent material that fills all space axially extending between an input surface of the respectively-corresponding first optical system and an output surface of the respectively-corresponding second optical system. (In such a case, such single block may be defined by an optically transparent housing shell filled with a fluid or defined by a spatially indivisible body of the optically uniform and optically transparent material that is a solid material. Furthermore, when this is the case, and when the embodiment includes a feature of an optical aperture formed in a respectively-corresponding plane of convergence in at least one constituent optical train, such optical aperture is preferably configured to include a notch or groove defined by or in a bottom surface of the block in a plane that is transverse to a respectively-corresponding optical axis and/or such optical aperture may be defined by structural features in a top surface of the block and the bottom surface of the block at the respectively-corresponding plane of convergence.)

Alternatively or in addition, practically every embodiment of the vehicular illumination system may be configured such as to maintain each first optical system of the array to remain spatially-invariably positioned and oriented with respect to another first optical system of the array; and/or to maintain each second optical system of the array to remain spatially-invariably positioned and oriented with respect to another second optical system of the array; and/or to maintain each third optical system of the array remain spatially-invariably positioned and oriented with respect to other third optical system of the array regardless of positioning and/or orientation of the first, second, and/or third optical systems with respect to one another. At least in the latter case, when each first optical system of the array is maintained to remain spatially-invariably positioned and oriented with respect to the other first optical system of the array and/or when each second optical system of the array is maintained to remain spatially-invariably positioned and oriented with respect to the other second optical system of the array, a portion of the vehicular illumination system that is axially limited by respectively-corresponding first optical systems and respectively-corresponding second optical systems may be configured as a block of substantially optically uniform and optically transparent material that fills substantially all space axially extending (present along the axis) between input surfaces of the respectively-corresponding first optical systems and output surfaces of the respectively-corresponding second optical systems. Such block may be either defined by an optically transparent housing shell filled with an optically transparent fluid or defined by a substantially indivisible body of the optically uniform and optically transparent material that is a solid material. When such portion of the vehicular illumination system includes a feature of an optical aperture formed in a respectively-corresponding plane of convergence of a chosen optical train, the optical aperture is preferably formed by (configured as) a notch or groove defined by or in a bottom surface of the block in a plane that is transverse to a respectively-corresponding optical axis of the chosen optical train and/or such optical aperture may be defined by structural features in a top surface of the block and the bottom surface of the block at the respectively-corresponding plane of convergence.

Alternatively or in addition, substantially every embodiment of the vehicular illumination system nay be configured such that a first optical system of at least one optical train of the array of optical trains includes an optical surface having a central portion and a peripheral portion surrounding the central portion (here, central portion of such optical surface is preferably configured as a surface of a lens to receive one fraction of light from the source of light when the latter is placed at the object location and to converge such first light towards the respectively-corresponding plane of convergence while the peripheral portion is configured as a surface of an optical reflector to receive another fraction of that light that has passed through an auxiliary portion of the optical surface and to converge this other fraction of light towards the respectively-corresponding plane of convergence. In this specific case, the auxiliary portion of the optical surface is made to connect the central portion of the optical surface with the peripheral portion of the optical surface and/or the optical surface is made substantially spatially uninterrupted. Substantially in every implementation, the array of optical trains is preferably configured such that third beams of light, produced by respectively-corresponding optical trains, substantially overlap at a target illumination plane defined at a separation distance of at least 25 meters from the third optical systems of the embodiment. Alternatively or in addition, in every implementation the array of optical trains may be and preferably is configured to form a light distribution in an illumination plane (defined at a separation distance of at least 25 meters from the third optical system) such as to satisfy requirements of a low beam profile defined by an FMVSS108 standard and/or by an R149e standard. Embodiments of the invention additionally provide a method that includes—with the use of any and/or every of the above-identified embodiments of a vehicular illumination system—forming a light distribution in an illumination plane defined at a separation distance of at least 25 meters from the third optical system, wherein the light distribution satisfies requirements of a low beam profile defined by an FMVSS108 standard and/or by an R149e standard.

Embodiments of the invention additionally provide a method that includes propagating light from a first source of light through a first optical train of an array of optical trains. Such propagating is effectuated by (i) transmitting this light through a first optical system of the first optical train (having an optical axis) to form first light converging towards a plane of convergence of the first optical system, (ii) collecting the first light with a second optical system of the first optical train to form a second light directed through the second optical system (here, the second optical system is positioned such as to have its back focal plane substantially coincide with the plane of convergence of the first optical system; the second light has a first degree of convergence in a first plane and a second degree of convergence in a second plane, each of the first and second planes containing the optical axis, the first and second planes being transverse to one another), and (iii) transmitting the second light through a third optical system to form third light that has a third degree of convergence in the first plane, the third degree being different from the first degree. In at least one specific case, the step of transmitting light from the first source of light through a first optical system of the first optical train may include (a) transmitting such light through an input surface of the first optical system (which input surface includes a central portion configured as a surface of the lens, a peripheral portion configured as an optical reflector and surrounding the central portion, and an auxiliary portion connecting the central portion and the peripheral portion) and/or transmitting such light from the first source of light through the central portion and the auxiliary portion and reflecting the first light at the peripheral portion. Alternatively or in addition, in substantially every implementation of the method the step of collecting said first light may include forming the second light with the first degree of convergence that is substantially equal to the second degree of convergence, and/or forming the second light with the first degree of convergence and the second degree of convergence being substantially zero. (In at least one of the latter situations, the method may additionally include a step of transmitting light through an optical aperture formed in the plane of convergence, such that—if desired and preferred—a spatial distribution of the first light in the plane of convergence is not optically conjugate to that at the source of light.)

Substantially every embodiment of the method may additionally or in the alternative include—carried out substantially contemporaneously with the propagating light from the first source of light—a step of propagating light from a second source of light through a second optical train of the array of optical trains. Here, the second optical train including a corresponding first optical system, a corresponding second optical system, and a corresponding third optical system of the second optical train. When this is the case, the step of propagating light from the second source of light through the second optical train may be configured to include forming a spatial distribution of the light from the second source of light in a plane of convergence of the corresponding first optical system of the second optical train such that this spatial distribution is necessarily not optically conjugate to that at the second source of light and/or to have the corresponding second optical system of the second optical train be positioned with a back focal plane thereof to be substantially coincident with the plane of convergence of the corresponding first optical system of the second optical train.

Alternatively or in addition, in substantially every implementation of the method the process of propagating light from the first source of light may include propagating light through the input surface of the first optical system of the first optical train, propagating such light through a substantially optically transparent and substantially optically uniform medium that substantially spatially uninterruptingly connects the input surface of the first optical system from an output surface of the second optical system of the first optical train, and propagating such light through a free space separating the output surface of the second optical system and an input surface of the third optical system of the first optical train. (Similarly, in cases when the second optical train is present, the implementation of the method may be configured to include propagating light from the second source of light through the input surface of the first optical system of the second optical train, propagating such light from the second source of light through a substantially optically transparent and substantially optically uniform medium that substantially spatially uninterruptingly connects the input surface of the first optical system of the second optical train from an output surface of the second optical system of the second optical train, and propagating such light from the second source of light through a free space separating the output surface of the second optical system of the second optical train and an input surface of the third optical system of the second optical train.) The process of propagating light from the first source of light may include propagating such light through an optical aperture, of the first optical train, formed in the plane of convergence of the first optical system of the first optical train and dimensioned such as to have a light distribution, formed upon transmission of this light through the third optical system of the first optical train, to have a substantially zero luminous intensity above a horizon plane. (Similarly, when the second optical train is present, the process of propagating light from the second source of light may be configured to include propagating such light through an optical aperture of the second optical train that is formed in a plane of convergence of the first optical system of the second optical train and dimensioned such as to have a light distribution, formed upon transmission of this light through the third optical system of the second optical train, to have a substantially zero luminous intensity above a horizon plane.)

Substantially in every implementation of the method, the array of optical trains is configured such that portions of light respectively transmitted through the third optical system of the first optical train and through the third optical system of the second optical train substantially overlap at an illumination plane defined at a separation distance of at least 25 meters from said third optical system of the first optical trains and the third optical system of the second optical train, and/or such as to form the light distribution at the illumination plane to satisfy requirements of a low beam profile defined by an FMVSS 108 standard and/or by an R149e standard.

### BRIEF DESCRIPTION OF THE DRAWINGS

The invention will be more fully understood by referring to the following Detailed Description of Specific Embodiments in conjunction with the Drawings, of which:

FIG. 1 provides a schematic perspective illustration of a modular implementation of the idea of the present invention, in which the array of first optics (shown as an array of near-field light concentrators) directly receiving light from multiple light sources and relaying it towards the target illumination plane is judiciously optically mapped to the array of second optics (the projection lenses) such that there exists a one-to-one correspondence between the two, and the latter is further optically mapped to the array of the light-spread lenses such that there exists a one-to-one correspondence between the two.

FIG. 2 provides a schematic cross-sectional sketch of the embodiment of FIG. 1, depicting the array of output lenses (each defining an exit aperture of a given optical train, in which a respectively-corresponding spatially-distinct projection lens is dedicated to collecting light from a given near-field light concentrator) dimensioned to affect the spatial divergence of corresponding light beams in a single spatial plane only.

FIG. 3 is a schematic illustration of a constituent light-concentrating element in related to the plane of convergence.

FIGS. 4A, 4B provide contour plots of typical low-beam light distribution in an illumination plane produced by an embodiment of the invention and a conventional vehicular illumination system of related art.

FIGS. 5A, 5B are schematic representations of an embodiment of a housed vehicular illumination system configured according to the idea of the invention.

FIGS. 5C, 5D are schematic representations of a typical embodiment of a housed vehicular illumination system of related art.

FIGS. 6A, 6B schematically illustrate respective optical systems of an embodiment of the invention and that of related art in perspective view.

FIGS. 7A, 7B present schematics of an embodiment of the invention and that of related art in top views.

FIGS. 8A, 8B present schematics of an embodiment of the invention and that of related art in side views.

FIGS. 9A, 9B present schematics of an embodiment of the invention and that of related art in front views.

FIGS. 10A, 10B illustrate portions of a related but non-exclusive embodiment of the invention in plan and perspective views, respectively, with indication of not visible elements in dashed lines.

FIGS. 11A, 11B illustrate, respectively, the portions of the embodiment of FIGS. 10A, 10B in plan and perspective views.

FIG. 12 presents a cross-section of the embodiment of FIGS. 10A, 10B, 11A, 11B in a plane that is substantially parallel to an axis of a constituent optical train of the embodiment.

Sizes and relative scales of elements in Drawings may be set to be different from actual size and scales to appropriately facilitate simplicity, clarity, and understanding of the Drawings. For the same reason, not all elements present in one Drawing may necessarily be shown and/or labeled in another.

### DETAILED DESCRIPTION

In accordance with preferred embodiments of the present invention, methods and apparatus are disclosed for forming light distribution (at the target plane of illumination of a vehicular illumination system) defined by various regulatory standards—such as, for example, the Motor Vehicle Safety Standard (MVSS) 108 and UN regulation (ECE) 149 at distances that are relatively far away from the lamp of the vehicle (typically, more than 25 meters). Notably, the sets of such requirements established by different regulatory bodies are substantially similar. Most of the illumination requirements set by industrial standards are listed as luminous intensity values in a polar coordinate system with the lamp at the center of such system. The following refers to some of the practical parameters that are addressed in such industrial requirements and that have to be satisfied during practical implementation of a vehicular illumination system. Notably, for the purposes of this disclosure and unless expressly defined otherwise, the term vehicular illumination system as used herein refers to and defines a predetermined combination of optical components forming an optical system that is configured to be used in a vehicle to project light from at least one source of light —such as a light bulb, an LED, or another source of light—to illuminate a road ahead. To this end, the source of light itself is not considered to be a part of the vehicular illumination system for the purposes of this disclosure and appended claims.

Low Beam. The term low beam (which may be interchangeably referred to as lower beam, or passing beam) is used to define a vehicular illumination pattern configured to illuminate as much of the roadway as possible in front of the vehicle, without causing too much glare for other traffic on that roadway, so that all vehicles are able to have good visibility of the road and immediate surroundings. The industrial and legal requirements for low beam in the United States are defined by the National Highway traffic Safety Administration's Federal Motor Vehicle Safety Standard 108 (NHTSA's FMVSS108) (available at ecfr.gov/current/title-49/subtitle-B/chapter-V/part-571/subpart-B/section-571.108), which for the purposes of this disclosure and appended claims is referred to by the term “an FMVSS108 standard”. The legal requirements for low beam in much of the rest of the world are governed by what is known as UN ECE regulation No. 149 (available at unece.org/sites/default/files/2021-05/R149e.pdf), which for the purposes of this disclosure and the appended claims is referred to by the term “an R149e standard”. In addition to legal requirements, a vehicle manufacturer, understandably, has performance expectations that are typically well above the minimum legal required illumination values.

Industry differentiates between symmetric and asymmetric versions of the low beam. The symmetric version is typically meant for motorcycles and ATVs, as well as construction and agricultural vehicles. The asymmetric version is used on automobiles and trucks, with left-hand and right-hand traffic versions, depending on the country the vehicle is intended to be driven in. Formation of a symmetric low beam type illumination field typically requires meeting the following conditions:
A general illumination zone characterized by about 400 to about 800 lumens, spread horizontally about 25° to both sides with respect to an axis of the illumination-defining beam of light, and, in a vertical plane, starting at the horizon and spread down about 15° below the horizon. (The terms plane of horizon or horizon plane may be used in this disclosure interchangeably with the term horizon.)
A central area of high luminous intensity, of about 10,000 to 20,000 candelas (with minimum legal value of 7,000 cd as described in the FMVSS 108 standard) located just below the horizon.
A “cut off” of radiant field at or just below the horizon. This industrial requirement sets a sharp gradient of irradiation/intensity, thereby separating the high level of illumination below the horizon and the low level of illumination above the horizon. The gradient of this “cut off” has a minimum figure of merit representing sharpness of such transition and associated with it (see Annex 6 section 4.1.2 of the R149e standard, G=(log Eβ−log E(β+0.1°)) with G >0.08).

High beam. The term high beam (which may also be interchangeably referred to as upper beam, or driving beam) is used to define a vehicular illumination pattern configured to illuminate the roadway and immediate surroundings, looking as far forward as possible. The legal requirements for this pattern are recited, again, in the FMVSS 108 standard and the R149e standard. The vehicle manufacturer will typically have requirements that exceed the legal minima. As known in related art, high beam is always required to be symmetric. A typical high beam vehicular illumination pattern is required to possess the following characteristics:
A maximum luminous intensity typically between 45,000 candelas and 75,000 candelas. (Such maximum is located typically near the center of the overall high beam illumination pattern, sometime referred to H-V where the horizon and a vertical plane coincident with the optical axis of the lamp intersect. If the maximum intensity is not at H-V, then the intensity at H-V must be at least 80% of the maximum.)
Some level of luminous intensity (typically 1,000 cd) present up to about 5 degrees above the plane of horizon.
Some level of luminous intensity present to the sides of the H-V point along the horizon. This requirement is typically set to 2,000 candelas at 12° on both sides from the vertical plane.

Daytime running lamp. The term daytime running lamp (DRL) is defined to refer to a signalization pattern that provides daytime conspicuity for vehicles. The legal requirements for these lamps are found in FMVSS 108 for the United States, but for almost any other jurisdiction—in UNECE Regulation 148 (available at unece.org/sites/default/files/2021-05/R148e.pdf). Since the advent of LED technology, vehicle manufacturers have utilized DRL to stylize the front of their vehicles. Generally, as long as it meets the legal requirements and has the aesthetic they are looking for, the manufacturers are satisfied. A typical DRL pattern has to satisfy the following requirements (see, for example, UNECE Reg 148, Annex 3 section 2.2 and table 6: (i) intensity of at least 500 cd at H-V (from FMVSS 108); (ii) intensity of at least 100 cd at 20° to each side (with respect to the vertical plane) along the plane of horizon; (iii) intensity of at least 80 cd at 10° above the horizon; and (iv) intensity of at least 280 cd at 5° below the plane of horizon.

It is understood, therefore, that embodiments of the present invention are configured to meet the above-identified legal/industrial requirements

Notably, illumination patterns formed by commonly-used vehicular lamps of related art persistently maintain what can be loosely referred to as chromatic aberration of sorts, of color patterning that can be visually perceived on the road.

The problem(s) of visually-perceived multicolored illumination of the target illumination plane (such as a road, along which a given vehicle travels, and/or a pre-determined plane in front of the vehicle) that persist in implementations of the vehicular systems of related art was solved by structuring the implementations of illumination system as an array of optical trains in each of which the element of the first optical system (the non-limiting examples of which are discussed below as reflector-based light concentrators) and the element of the second optical system (projection optical component in general and a projection lens in the examples presented below) are uniquely spatially mapped one into another. As a result, light from a given optical source of the employed arrays of optical sources necessarily interacts both with a dedicated, spatially-distinct light concentrator of the corresponding optical train and with a dedicated, spatially-distinct from the rest of the projection optical component while not interacting with either the light concentrator or the projection optical component of the neighboring optical train. The unexpected advantageous corollary of such configuration is freedom of overall shape now available to the designers of the vehicular illumination system the modifications of which, at the same time, do not cause substantial, if any, changes of the overall footprint (and/or volume factor) of the system as compared with a similarly-functioning conventionally-designed vehicular illumination system. In a specific implementation, the functions of defining a direction of propagation of light toward the target illumination plane and/or defining the target distribution of and level of irradiance at the target illumination plane are sub-divided between the projection optics of a given optical train and an additionally introduced third optical system, which is configured to vary a degree of divergence of light arriving from the second optical system in a single, uniquely defined spatial plane while, at the same time, defining an exit aperture of the optical train that is substantially smaller height than that of the conventional vehicular illumination systems. To address the persisting need to avoid an optical projection of the light source(s) used in a vehicular illumination system onto the target illumination plane, in at least one of the optical trains of the implementation of the system the light concentrator component (the first optical system) has a geometrical profile judiciously dimensioned to not form the optical image of the light source at a plane projected towards the illumination plane by the second optical system.

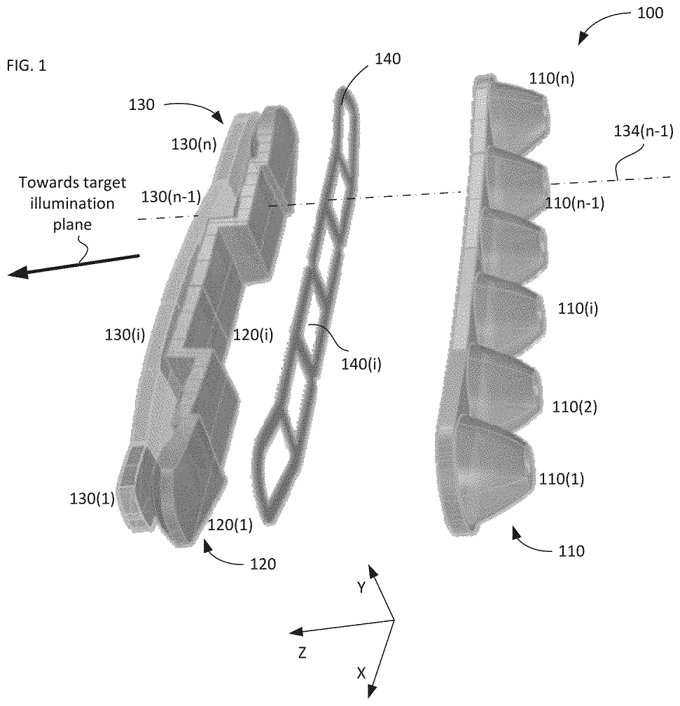

To this end, FIG. 1 schematically illustrates, in perspective view, an embodiment 100 of the vehicular illumination system structured according to the idea of the invention. As will be understood from the following discussion, the embodiment 100 represents the illumination system that contains separate, separable from one another different optical systems (while a related embodiment may be configured to include an indivisible optically-transparent block dimensioned to include multiple different optical constituent optical systems). Here, the embodiment is shown to include an array of n optical trains, each of which contains a corresponding first optical system 110(i) (that may be referred to as a light concentrator), a corresponding second optical system 120(i) (that may be referred to as a projection lens), and a corresponding third optical system 130 (that may be referred to as a light-spread lens), the index i ranging from 1 to n. Each of the optical trains has a corresponding optical axis (one on which is shown as 134(n−1)), and, as shown, in this embodiment the optical systems 110(i), 120(i), and 130(i) are separated from one another along these optical axes.

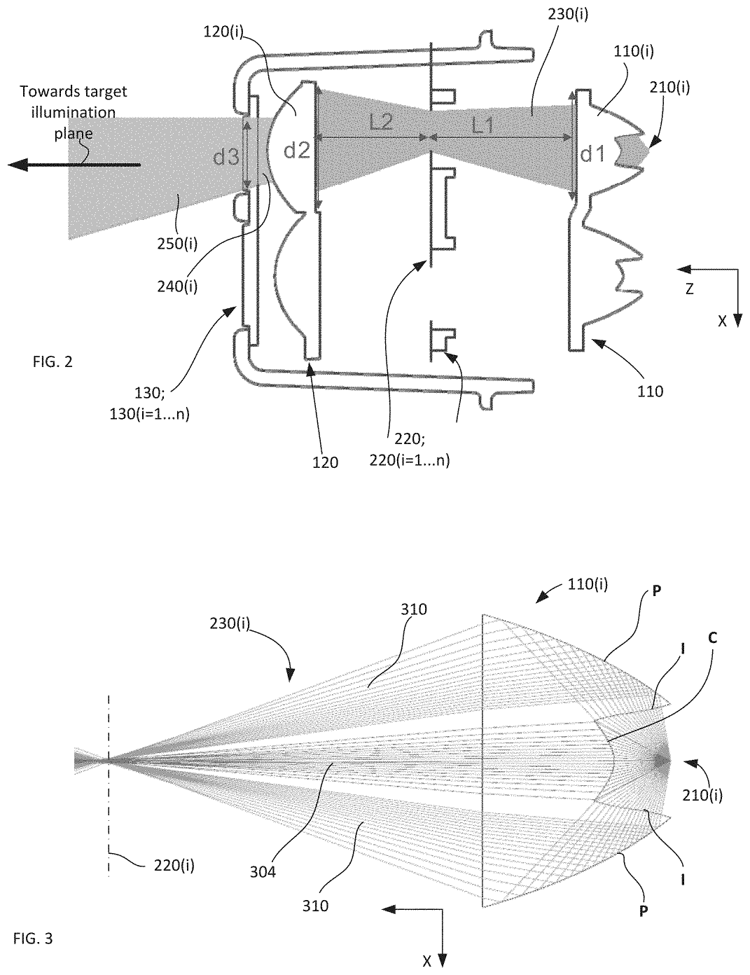

Referring additionally to FIG. 2, an array 110 of the constituent first optical systems is in at least one case configured as an array of light concentrators, each redirecting light received from a respectively-corresponding light source 210(i) such as an LED (disposed at an object distance with respect to and outside of the surface of the corresponding system 110(i); not shown in FIG. 1) towards the respectively-corresponding projection optical system 120(i). The outer surface of the array 110 of the first optical systems can be viewed as an input surface of the embodiment.

In further reference to FIG. 3, a given light concentrator 110(i) is shown in a cross-sectional view (with the addition of light rays emanating from the corresponding source of light, when present, and propagating through the surface of such light concentrator 110(i). An input surface of the individual first optical system (light concentrator) 110(i) is referred to herein as an entry surface and includes three portions: a central portion (marked C; dimensioned as a surface of a lens, optionally a positive lens) and a peripheral portion (marked P; circumscribing the central portion and, at least in one implementation, substantially symmetrical about a corresponding optical axis of the system 110(i) and configured as an optical reflector; the peripheral portion has the same sign of curvature as the central portion as understood in related art). The entry surface also includes an auxiliary or intermediate portion (marked as I; circumscribing the central portion and substantially spatially uninterruptingly connecting the central portion with the peripheral portion; in at least one implementation—substantially symmetrical about the corresponding optical axis). In at least one specific case, the overall input surface of the first optical system 110(i)—that is, the combination of the surfaces C, I, and P— may be made substantially rotationally symmetric about the corresponding optical axis, which is indicated in FIG. 3 as the z-axis. As will be clear from further discussion, such structure of the input surface of the embodiment remains substantially the same regardless of whether the embodiment is structured to include spatially-separable optical systems 110, 120 or an indivisible optically-transparent block dimensioned to include these different optical systems. In at least one specific implementation, the surface containing the central, intermediate, and peripheral portions C, I, and P is dimensioned to be substantially spatially uninterrupted.

The light concentrator 110(i) is configured such that, when a light source 210(i) is placed at an object point (appropriately separated from the vertex of the central portion of the entry surface), as shown in FIG. 3, a fraction 304 of light from the source 210(i) penetrates/is transmitted through the central portion C of the entry surface, while another fraction 310 is transmitted through the intermediate portion I and then reflected off of the peripheral portion P. Aggregately, these fractions of light 304, 310 form the beam of light 230(i) passed from the first optical system 110(i) to the second optical system 120(i) of the i-th optical train of the embodiment of the overall illumination system.

Typical dimensions of the system 110(i) are as follows: the radial extent of the central portion C is from about 1 mm to about 6 mm; the inner diameter of the peripheral portion P is from about 2 mm to about 10 mm; the outer diameter of the peripheral portion P is from about 10 mm to about 20 mm; the axial length of the system is about 7 mm to about 30 mm; and the axial separation between the outmost point of the peripheral portion P on the side of the source 210(i) and a point at a perimeter of the central portion C is from about 2 mm to about 12 mm.

As illustrated in FIGS. 2 and 3, the entry surface of the optical system 110(i)—and, for that matter, the input surface of the array 110—is/are judiciously dimensioned such that, upon the transfer of light from the source 210(i) to the projection optical system 120(i), the array 110 of the first optical systems 110(i) converges the light at the plane of convergence 220 and, in particular, the constituent first optical system 110(i) converges the light at the local plane of convergence 220(i) (the plane(s) of convergence are not shown in FIG. 1).

For the purposes of this disclosure and unless expressly defined otherwise, a plane of convergence of illuminating light, formed by an optical component or system collecting light from a source of light and relaying such light down the optical axis of such component or system, is defined as a plane which is drawn substantially perpendicularly to the optical axis and in which the size of transverse distribution of light is smaller than in any other plane parallel to the plane of convergence. In a conventional optical imaging system—as understood in related art—that is configured to form an optical image of a chosen object placed at a point separated from such optical imaging system by an object distance, the image plane (which is separated from such optical imaging system by an image distance and in which a real image of the object that is optically-conjugate to the object is formed) is a plane of convergence of light emanating from the object. Generally, however, and depending on the specific implementation of the optical component or system, the light distribution formed in the plane of convergence may or may not be optically-conjugate to the light distribution at the object plane. (In the latter case, the optical component or system cannot be reasonably considered by a skilled person to be an optical imaging system as understood in related art).

In at least one specific case, and in contradistinction with the conventional designs, at least one given light concentrator 110(i) of the array 110 may be intentionally dimensioned to form the respectively-corresponding beam of light 230(i) with such distribution of light in the respectively-corresponding plane of convergence that is intentionally not optically-conjugate to that at the respectively-corresponding location of the object 210(i) (the object location). Accordingly, if and when this is the case, the corresponding i-th is not an optical imaging system. Understandably, in this specific case, the light distribution formed by the system 110(i) in the plane of convergence of illuminating light is intended to not form an optical image of the source 210(i) but, instead, generates a blurred distribution of light that is spatially more uniform that that corresponding to the optical image of the source 210(i), thereby increasing the spatial uniformity of the overall light distribution in at least a portion of the target illumination plane.

Generally, as was already alluded to above, each i-th optical train of the embodiment 100 contains a corresponding plane of convergence 220(i) and the multiplicity of the constituent planes of convergence of the embodiment 100 forms a surface of convergence of illuminating light. It is understood that in one specific embodiment, the dimensions of the array 110 may be chosen such that all constituent planes of convergence are substantially coincident with one another. The size of the output aperture of the light concentrator 110(i) is denoted as d₁, the clear aperture of the converging optic 120(i) is marked as d₂, and the size of the exit aperture of the exit optic 130(i) is labelled as d₃. Some of the corresponding longitudinal separations between the components of the i-th optical train of the array 100 are marked as shown (for example, L₁, L₂).

Referring again to FIGS. 1A, 1B, and FIG. 2, a given second (projection) optical system 120(i) of the array 120 is configured to have its back focal plane substantially coincide with the corresponding plane of convergence of illuminating light defined by the first optical system 110(i) and to form a beam of light 240(i) directed towards the target illumination plane. In one case, the system 120(i) may be dimensioned as an aspheric plano-convex lenslet and, depending on the specifics of a particular implementation, the beam 240(i) in the far-field may be substantially collimated or slightly diverging (for example, within an angular range not to exceeding +/−10 degrees) to minimize the transverse dimensioned of the respectively-corresponding third optical system, 130(i), that captures the light in the beam 240(i). In at least one case is intended to change the spatial divergence of the light beam 240(i) emerging through the respectively-corresponding system 120(i) in only one plane containing the optical axis 134(i) while substantially maintaining the spatial divergence of the beam 240(i) in light output 250(i) directed by the system 130(i) towards the target illumination plane. (For the sake of identifying orientation, the local Cartesian system of coordinates is shown.) In at least one case, a degree of spatial divergence (or convergence) of the beam 240(i) in a first plane containing the optical axis of the corresponding i-th optical train may be different from a degree of spatial divergence (or convergence) of the same beam in a second plane that also contains the optical axis and that is transverse to the first plane.

An output surface of the array 120 of projection lenses 120(i)—that is, the surface facing away from the array 110 of the corresponding optical systems 110(i)—includes a multiplicity of the output surfaces of the lenses 120(i) that may be referred to as exit surfaces. Understandably, each exit surface of the array 120 is preferably coaxial with a respectively-corresponding entry surface of the array 110.

At least some of the lenses 130(i) of the lens array 130 may be dimensioned, therefore, as cylindrical lenslets to additionally spread light in the horizontal direction only, to satisfy industrial and legal requirements. (The skilled artisan will readily appreciate that, while the additional horizontal “spread” of light created by the lens 130(i) of the third optical system of the embodiment could be alternatively achieved with modifications to the primary concentrator system 110(i) and the projector system 120(i), the size of the overall system in such alternative case would be inevitably significantly increased—in horizontal direction, by at least about two-fold—to achieve the same result, which understandably prevents and/or limits the use of such alternative solution in practice.) Accordingly, in at least one implementation, the third optical system 130—the array of light-spread lenses 130(i)—may be configured such a degree of divergence (or convergence), in the first plane, of light received by a lens 130(i) from the corresponding lens 120(i) is different from that, in the same first plane, of light received by the lens 130(i) from the lens 120(i).

Notably, to increase the spatial spread of the beam 240(i) upon the transmission of this beam through the light-spread lens 130(i), the light-spread lens 130(i) may include “flutes” (which term is defined herein to refer to refractive and/or reflective surfaces having a substantially infinite radius of curvature along one axis and a non-infinitesimal radius of curvature along another axis to increase a degree of divergence of a light beam only in one chosen plane) and, if and when the modification of the spatial divergence of the beam 240(i) is desired in two perpendicular planes, such lent may include “pillows” (which term is defined herein to refer to refractive and/or reflective surfaces having non-infinitesimal radius of curvature along each of the chosen mutually-transverse axes). Referring again to FIGS. 1, 2, optionally a shutter/aperture stop 140(i) may be additionally disposed or formed in the embodiment, in the corresponding plane of convergence 220(i) when and if creation of a sharp spatial gradient of irradiance distribution in the target illumination plane is desired (which may be beneficial to the formation of a low-beam portion of the light output of a vehicular headlamp). Various aperture stops may be aggregated into a modular component dimensioned as a shutter or aperture array 140, as shown in the examples. Generally, such shutter/aperture array 140 is an optional part of the overall illumination system and can be employed to create a relatively sharp gradient in the illumination pattern at the target illumination plane by blocking a portion of the virtual image created by the array 110 of light concentrators, which may be of importance for the creation of a low beam or dipped beam pattern. An embodiment 100 has a well-defined upper side (top) and lower side (bottom): the former is a portion of the embodiment that will be facing away from the road when installed on a vehicle, while the latter is a portion of the embodiment that will be facing the road when installed on the vehicle. Considering this orientation, the term horizon plane or a plane of horizon or a similar term is defined as a plane that contains multiple axes of the optical trains present in a given embodiment of the illumination system. Generally, an optical aperture formed is dimensioned such as to have a light distribution, generated by the at least one of the first and second optical trains, substantially not have luminous intensity above the horizon plane.

Examples of typical dimensions of the embodiment include, in reference to FIG. 2: d1 from about 10 mm to about 30 mm; d2 from about 5 mm to about 40 mm; d3 from about 5 mm to about 30 mm; L1 from about 5 mm to about 50 mm; L2 from about 5 mm to about 40 mm; and the total axial distance of separation between the first optical system 110(i) to the respectively-corresponding third optical system 130(i) from about 25 mm to about 150 mm. In practice, materials used for implementation of the arrays 110, 120, 130 are preferably thermoplastic (such as polycarbonate, OPC; acrylic, PMMA; and, optionally, polystyrene, PS; cyclic olefin polymer and copolymer, COC & COP; polyester, OKP)

Each i-th optical train of the embodiment has a corresponding optical axis that is defined by the combination of the respectively-corresponding first optical system 110(i) and second optical system 120(i). The transverse (in the plane of horizon) separation between the neighboring optical axes of the neighboring optical trains of the embodiment is preferably within the range from about 7 mm to about 40 mm, while the overall axial extent of the overall embodiment is preferably between 20 mm and 150 mm. In practice, the number of optical trains of the embodiment may vary but is preferably between 2 and 15.

In at least one embodiment of the invention, elements of a given “optical layer” of the overall apparatus (be it an array of light concentrators and/or an array of projection lenslets and/or an array of the exit light-spreading optical elements) may be co-molded with one another to not only reduce the costs associated with fabrication of the embodiment of the invention, but, more importantly, facilitate the process of alignment of the systems with respect to one another with pre-determined limits of tight spatial tolerances (which are smaller than the assembly tolerances usually prescribed for spatial coordination of separate elements of the systems of related art). Accordingly, the embodiment of the vehicular illumination system is configured to maintain each first optical system of the array to remain spatially-invariably positioned and oriented with respect to each other first optical system of the array; and/or to maintain each second optical system of the array to remain spatially-invariably positioned and oriented with respect to each other second optical system of the array; and/or to maintain each third optical system of the array remain spatially-invariably positioned and oriented with respect to each other third optical system of the array regardless of positioning and/or orientation of the first, second, and/or third optical systems with respect to one another.

The skilled artisan having an advantage of this disclosure a method of utilizing any and every of variations of the embodiment of a vehicular illumination system (whether those discussed above, or those discussed below) includes propagating light from a first source of light through a first optical train of an array of optical trains by. Such propagating includes at least the step of (a) transmitting such light through a first optical system of the first optical train (that has an optical axis) to form first light converging towards a plane of convergence of the first optical system, (b) collecting the first light with a second optical system of the first optical train to form a second light directed through the second optical system. Here, the second optical system is positioned to have a back focal plane thereof substantially coincide with the plane of convergence of the first optical system; the second light may have a first degree of convergence in a first plane and a second degree of convergence in a second plane (each of the first and second planes contains the optical axis, while the first and second planes are transverse to one another). The process of propagating the light also includes a step of transmitting the second light through a third optical system to form third light that has a third degree of convergence in the first plane (the third degree being different from the first degree). Notably, the step of transmitting light from the source through a first optical system of the first optical train includes at least one of (i) transmitting such light through an input surface of the first optical system (wherein the input surface includes a central portion configured as a surface of the lens, a peripheral portion configured as an optical reflector and surrounding the central portion, and an auxiliary portion connecting the central portion and the peripheral portion) and (ii) transmitting such light through the central portion and the auxiliary portion and reflecting the first light at the peripheral portion. Furthermore, a method of utilizing substantially every implementation of the vehicular illumination system (whether one of those discussed above or one of those discussed below) includes at least forming a light distribution (in an illumination plane defined at a separation distance of at least 25 meters from the third optical system of the embodiment) such as to have this light distribution satisfy the requirements of a low beam profile as defined by an FMVSS108 standard and/or by an R149e standard.

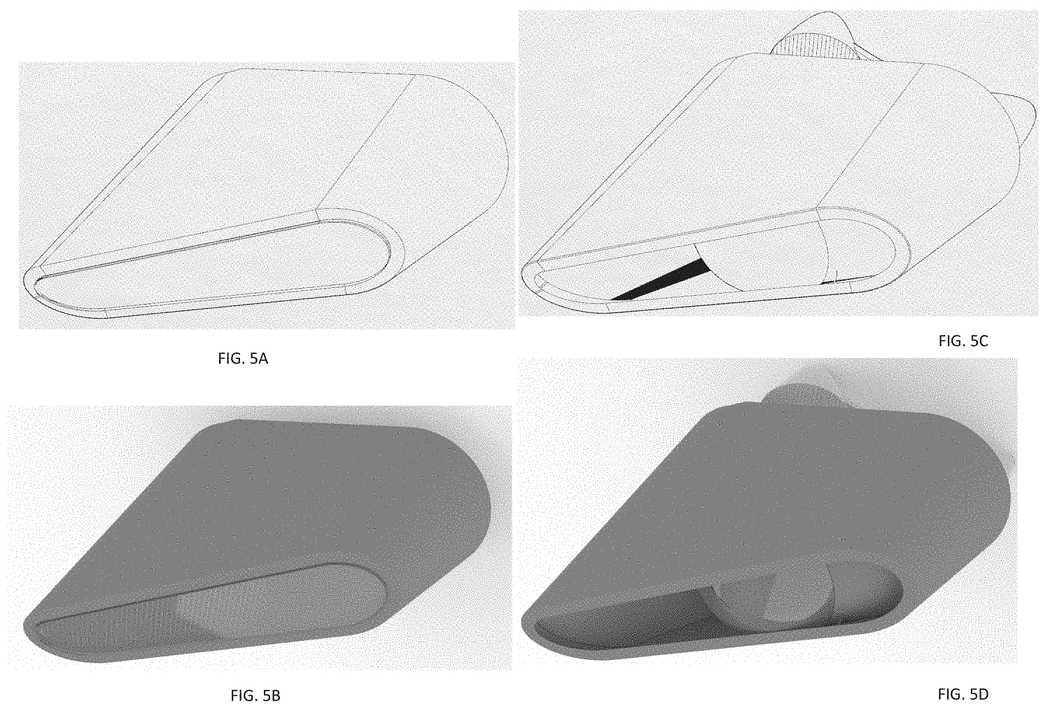

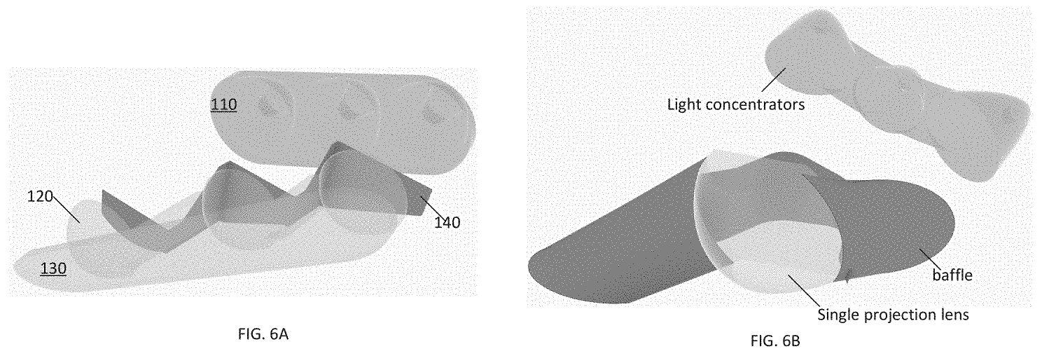

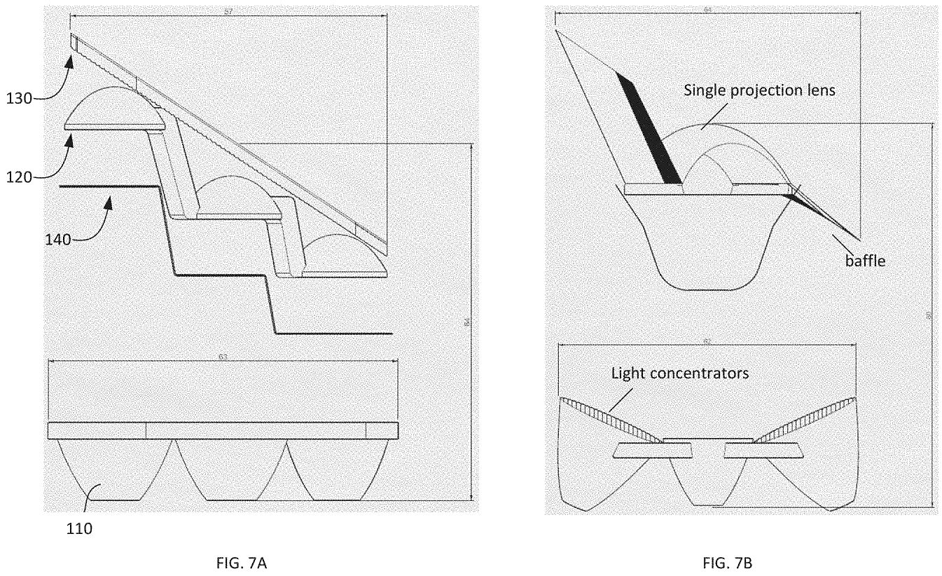

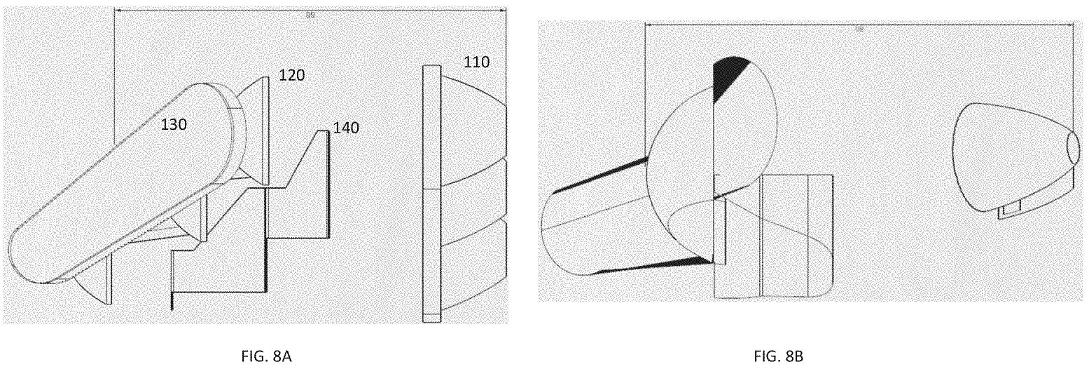

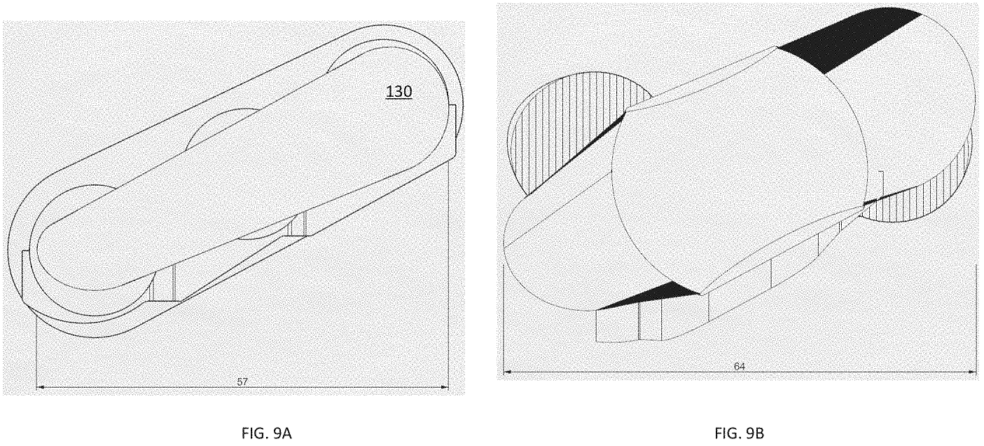

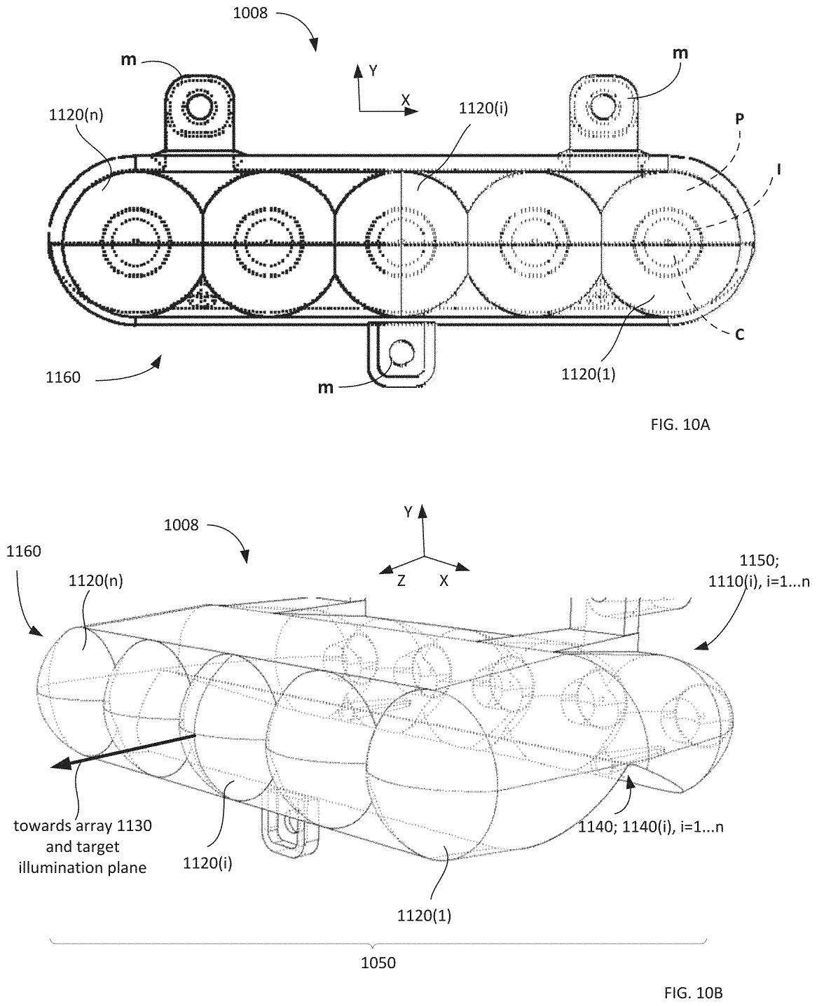

For the purposes of visual comparison between an embodiment of the vehicular illumination system configured according to the idea of the present invention and a typical vehicular illumination system of related art, FIGS. 5A, 5B present a silhouette and a perspective view of the embodiment while FIGS. 5C, 5D present a silhouette and a perspective view of a typical system of related art, each contained in a corresponding housing shell; FIG. 6A presents a perspective view of constituent components of the embodiment spatially-coordinated with one another while FIG. 6B provides a perspective view of constituent components of the typical system of related art; FIG. 7A presents a schematic top view of constituent components of the embodiment spatially-coordinated with one another while FIG. 7B provides a schematic top view of constituent components of the typical system of related art; FIG. 8A presents a schematic side view of constituent components of the embodiment spatially-coordinated with one another while FIG. 8B provides a schematic side view of constituent components of the typical system of related art; FIG. 9A presents a schematic front view of constituent components of the embodiment spatially-coordinated with one another while FIG. 8B provides a schematic front view of constituent components of the typical system of related art.

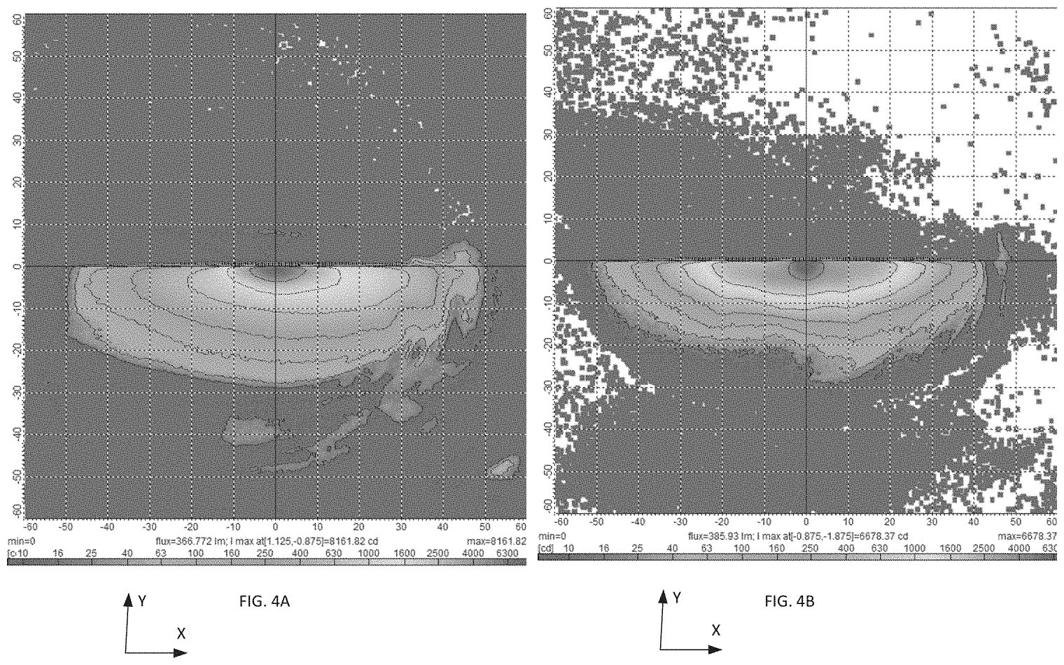

A person of ordinary skill in the art will readily recognize that, in contradistinction with an embodiment of the present invention, there is no unique one-to-one correspondence between light-concentrator elements and projection lens elements in a system of related art (in the example shown, all of light-concentrator elements are optically mapped to the same, single projection lens). In addition, the optical components configured to perform the function of the array 130 of the embodiment of the present invention are not present in the system of related art. Generally, different lenslets 120(i) of the projection array 120 may be disposed at different separation distances (along the local optical axes of respective optical trains 1 . . . n) from the respectively-corresponding elements of the light-concentrator array 110 to make output beams of light from each of the constituent optical trains overlap at the target illumination plane such as form the spatial distribution of luminous intensity at the target illumination plane that satisfies the above-identified industrial/legal requirements. FIG. 4A provides a plot representing a low-beam portion of such distribution, which has been measured to satisfy both the FMVSS108 standard and the R149e standard, in comparison with the less-symmetric analogous distribution produced by a system of related art, shown in FIG. 4B. The skilled artisan will readily appreciate that an embodiment of the invention produces a spatial distribution of light, in the target illumination plane that is separated from the output surface of the array 130 by at least 25 meters, that substantially does not extend above the plane of horizon (shown here as the xz-plane).

In reference to the result displayed in FIGS. 4A, 4B:

| Embodiment | Related |
|---|---|
| 100 | Art |

| | | |
|---|---|---|
| Luminous efficiency¹ | ~40% | ~32% |

| | | | | |
|---|---|---|---|---|
| Center System Depth | 65 | mm | 80 | mm |
| Development Effort (time)² | 100 | hours | 150 | hours |

| | | |
|---|---|---|
| Number of Optical Layers | 4 | 3 |
| (components in each optical train) | | |

| | | | | |
|---|---|---|---|---|
| Tolerance Sensitivity³ | ±0.10 | mm | ±0.15 | mm |

Here: 1—The low-profile approach uses high luminance sources and starts with 900 lumen input, while the normal projection approach starts with 1200 lumen input from normal automotive style LEDs; 2—The development time is an estimate based on a conceptual design, not a fully optimized, “ready to tool” optical design. The low-profile approach has an advantage in that the distribution can be modified vertically and horizontally independently; 3—The low-profile approach has tighter tolerances requirements in general. The tolerance shown is the positional source tolerance, as an example.

Now the attention of the reader is drawn to a related—but not limiting and not excluding the above-discussed implementations of the idea of the invention—embodiment configured such as to have at least the same portion of each and every optical train of the embodiment be structured as a judiciously shaped block of optical material. The purpose and practical advantage of such an alternative configuration will be readily understood by the skilled person upon considering the remaining complexity of assembly of the embodiment of the vehicular illumination system configured as per FIG. 1—that is, the one in which all of the multiple “optical layers” of the overall apparatus—the arrays of the optical systems 110, 120, and 130—have to be aligned and coordinated with one another to achieve the desired result of forming a light distribution (in an illumination plane defined at a separation distance of at least 25 meters from the third optical system of the embodiment) that satisfies the requirements of a low beam profile as defined by an FMVSS108 standard and/or by an R149e standard

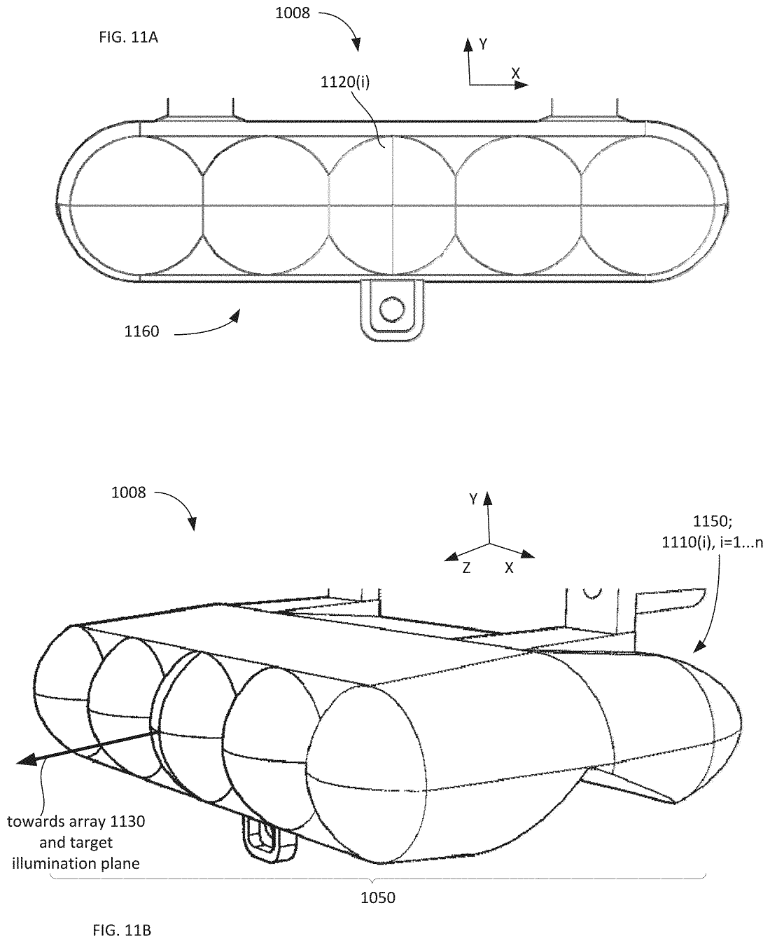

Accordingly, in a related embodiment, a portion 1008 of which is schematically illustrated in FIGS. 10A, 10B, 11A, 11B, and 12, at least the first and second arrays 110, 120 of the corresponding optical systems 110(i), 120(i)—and, preferably, also the light shutter array 140—may be intentionally and judiciously combined such as to be defined/formed/configured in a single block 1050 of an optically transparent material. In such a case, to complete an embodiment of the overall vehicular illumination system, the array of 130 of the light-spread lenses 130(i) is used as the only remaining an additional component spatially separable from and combined with such block.

The following discussion is presented in reference to FIGS. 10A, 10B, 11A, 11B, 12. Here, the array corresponding to and performing the function of the array 110 of FIG. 1 is denoted as 1110, the array corresponding to and performing the function of the array 120 of FIG. 1 is denoted as 1120, the generally optional structural feature(s) configured to correspond to and perform the function of the array 140 of FIG. 1 is denoted as 1140. Notably, if and when the optional feature 1140 is present, its location in the block 1050 along the optical axis (which substantially corresponds to the local z-axis) is preferably in a plane corresponding to the plane of convergence of light defined by the array 1110. Preferably—by analogy with an embodiment discussed in reference to FIGS. 1, 2, and 3—at least one and preferably each of the optical systems 1110(i) of the array 1110 is configured such as to have the distribution of light (received by the optical system 1110(i) from a source of light positioned outside of and before the block 1050) formed in the corresponding plane of convergence of the system 1110(i) be intentionally not optically conjugate with and/or to that at the corresponding source of light.

The array corresponding to and performing the function of the array 130 of FIG. 1 is not shown for simplicity of illustration, is intended to be a stand-alone array of light-spreading lenses located down the optical axis from the output surface of the array 1120. The location of the corresponding plane(s) of convergence associated with and defined by the first optical system(s) is indicated as 1140, 1140(i) (where i=1 . . . n). The structural features illustrated in FIG. 10A as m may be optionally formed for mounting and/or cooperation of the embodiment 1008 with a body of the host vehicle and, whether shown or not shown in the Figures, will not be discussed here in any detail.

Understandably, the single block 1050 may have different incarnations, such as, in one case, the one containing an outer optically transparent housing or shell (made of, for example, a chosen plastic material) filled with an optically transparent fluid (whether liquid or gas). In a related more practical case, however, such block can be simply molded as a spatially indivisible body of a chosen optically transparent material, for example a thermoplastic (such as polycarbonate, OPC; acrylic, PMMA; and/or polystyrene, PS; cyclic olefin polymer and copolymer, COC & COP; polyester, OKP.

Considering, for example, a situation in which the block 1050 is configured as a substantially spatially indivisible block of the optical transparent material, such block has an input surface 1150 (limiting the block 1050 on the light-input side where the source(s) of light are cooperated with the system 1008 in practice), the output surface 1160 (limiting the block 1050 on the light-output side that faces the not-shown and optionally spatially indivisible array 1130 of light-spread lenses), the upper surface and the bottom surface, and two side surfaces—all of which, aggregately, limit the volume of the block 1050. For the purposes of performing the function of illumination of the target illumination plane, however, the input surface, the output surface, and the bottom surface play specific roles.

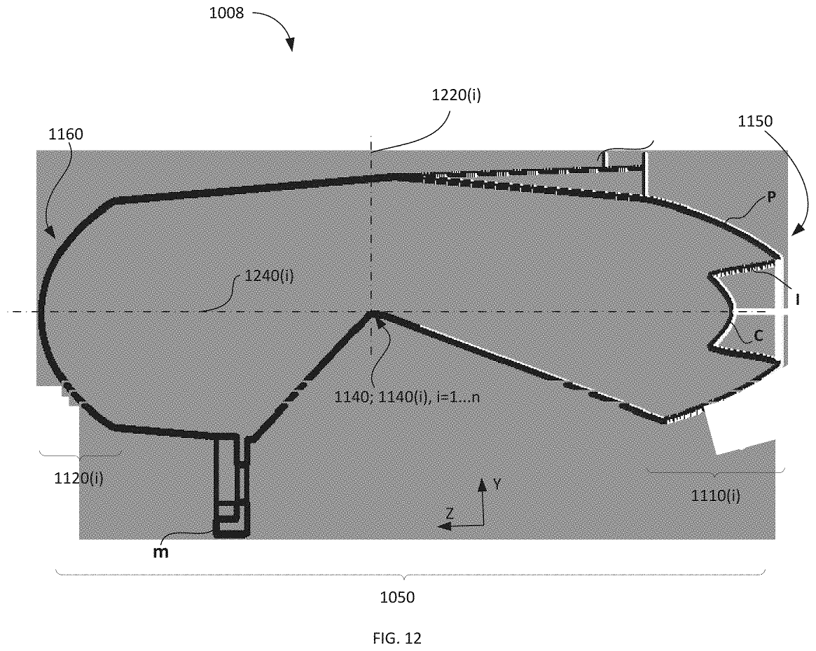

The overall input surface 1050 includes input surfaces of individual optical systems 1110(i), each of which can be considered to be a corresponding entry surface. By analogy with the portion of embodiment 100 discussed in reference to FIG. 3, each of such entry surfaces of the individual constituent optical systems 1110(i) also similarly includes the central portion C, the peripheral portion P, and the intermediate or auxiliary portion I, as schematically shown in FIGS. 10A and 12. The overall output surface 1160 of the block 1050 includes the output surfaces of the individual constituent optical systems (configured as projection lenses) 1120(i), each of which can be considered and referred to as a corresponding exit surface. See, for example, FIGS. 10B and 12. The combination of the respectively corresponding entry and exit surfaces defines a corresponding optical axis (about which such entry and exit surfaces are preferably co-axial) and, aggregately with a respectively corresponding light-spread lens 1130(i)—not shown in FIGS. 10A, 10B, 11A, 11B, 12—form an individual optical train of the illumination apparatus or system 1008.

The preferably indivisible array 1130 of light-spread lenses 1130(i) is disposed at a non-zero separation from the output surface 1160 such that each of said light-spread lenses is in one-to-one correspondence with a corresponding exit surface 1120(i) of the output surface 1160. At least in one implementation, the array 1130 of light-spread lenses is curved in the plane of horizon and/or different exit surfaces 1120(i) of the output surface 1160 are separated from the respectively-corresponding different entry surfaces of the embodiment 1008 by different distances. Preferably, the input surface is spatially continuous and does not include an opening therein within boundaries thereof and/or the output surface is spatially continuous and does not include an opening therein. Substantially in every implementation, all optical axes of the individual constituent optical trains defined by respectively-corresponding co-axial entry surfaces and exist surfaces, may be arranged in a common plane which—in at least one specific case—is substantially coincident with the plane of horizon.

Generally, the embodiment 1008 is configured such as to ensure that light, delivered from a source of light positioned on a given optical axis 1240(i) (defined by a combination of respectively-corresponding entry and exit surfaces of the block 1050) to a respectively-corresponding light-spread lens 1130(i) through the input surface 1150, through a body of the block 1050 separating the output surface 1160 from the input surface 1150, and through the output surface 1160 and transmitted through such light-spread lens, substantially does not propagate above the plane of horizon.

In further reference to FIGS. 10B, 11B, and 12, the bottom surface of the block is dimensioned to form a groove or notch that defines an (internal to the block 1050) edge truncating light propagating through a given entry surface and through a body of the block towards a respectively-corresponding exit surface along a corresponding optical axis of a constituent optical train of the system 1008. This groove or notch—denoted as 1140(i) for the i-th optical train—is judiciously dimensioned to function as an internal-to-the-block-body edge truncating light propagating through the body of the block from the system 1110 to the system 1120 (an optical knife edge, of sorts) such that such light substantially does not propagate above the plane of horizon upon transmission through a respectively-corresponding of the light-spread lenses 1130(i). (The other surfaces limiting the block 1050 are judiciously structured to not frustrate this effect.) Notably, due to the similarity of functions performed by the optical apertures 140(i) of the embodiment 100 and the optical edges 1140(i) of the embodiment 1008, the edge(s) 1140(i) are also considered to be optical apertures for the purposes of this disclosure. Preferably—but optionally nevertheless—such grove or notch is common for each of combinations of respectively-corresponding entry and exit surfaces and/or is formed in a plane of convergence 1220(i) of a first optical system 1110(i) formed by a chosen entry surface of the multiple entry surfaces of the input surface 1150.

In at least one—and optionally in every—implementation of the system 1008, the chosen entry surface is preferably configured such that a distribution of light—delivered from a respectively-corresponding source of light positioned outside of the entry surface of the constituent optical system 1110(i) on a respectively-corresponding axis through the chosen entry surface to the plane of convergence—is not optically conjugate to that at the source of light; while a back focal plane of second optical system formed by a corresponding exit surface of the optical system 1120(i) substantially coincides with the plane of convergence 1220(i).

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes. Other specific examples of the meaning of the terms “substantially”, “about”, and/or “approximately” as applied to different practical situations may have been provided elsewhere in this disclosure.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

While the invention is described through the above-described examples of embodiments, it will be understood by those of ordinary skill in the art that modifications to, and variations of, the illustrated embodiments may be made without departing from the inventive concepts disclosed herein. Accordingly, the invention should not be viewed as being limited to the disclosed embodiment(s).

What is claimed is:

1. A vehicular illumination system comprising:
an array of optical trains including a first optical train and a second optical train, each having a respectively-corresponding optical axis and including:
a first optical system configured to define, for a chosen respectively-corresponding object location, a respectively-corresponding plane of convergence of light collected from a respectively-corresponding source of light when said source of light is placed at the object location;
a second optical system disposed to have a back focal plane thereof substantially coincide with the plane of convergence of the first optical system, to receive the first beam of light and to form a respectively-corresponding second beam of light that has a first degree of convergence in a first plane containing the optical axis and a second degree of convergence in a second plane containing the optical axis and transverse to the first plane; and
a third optical system configured to transmit light from the second beam of light therethrough to form a respectively-corresponding third beam of light that has a third degree of convergence in the first plane, the third degree being different from the first degree.

2. A vehicular illumination system according to claim 1, wherein at least one of the following conditions is satisfied:
(2a) the first degree of convergence and the second degree of convergence are substantially equal to one another; and
(2b) the first degree of convergence and/or the second degree of convergence are substantially zero.

3. A vehicular illumination system according to claim 1, wherein at least one of the following conditions is satisfied:
(3a) a first optical system of the first optical train is configured to form the respectively-corresponding first beam of light with such distribution of light in the respectively-corresponding plane of convergence that is not optically-conjugate to that at the respectively-corresponding object location;
and
(3b) a first optical system of the second optical train is configured to form the respectively-corresponding first beam of light with such distribution of light in the respectively-corresponding plane of convergence that is substantially optically-conjugate to that at the respectively-corresponding object location.

4. A vehicular illumination system according to claim 1, further comprising, in at least one of the first and second optical trains, an optical aperture formed in the respectively-corresponding plane of convergence and dimensioned such as to have a light distribution, generated by the at least one of the first and second optical trains, substantially not have luminous intensity above a horizon plane.

5. A vehicular illumination system according to claim 1, wherein a portion of at least one optical train of the array of optical trains that is axially limited by a respectively-corresponding first optical system and a respectively-corresponding second optical system is configured as a single block of substantially optically uniform and optically transparent material that fills all space axially extending between an input surface of the respectively-corresponding first optical system and an output surface of the respectively-corresponding second optical system.

6. A vehicular illumination system according to claim 5, wherein either said single block is defined by an optically transparent housing shell filled with a fluid or said single block is defined by a spatially indivisible body of said optically uniform and optically transparent material that is a solid material.

7. A vehicular illumination system according to claim 5, wherein, when said portion of at least one optical train includes an optical aperture formed in a respectively-corresponding plane of convergence, said optical aperture is configured to include a notch or groove defined by or in a bottom surface of said block in a plane that is transverse to a respectively-corresponding optical axis of said at least one optical train and/or said optical aperture is defined by a top surface of the block and the bottom surface of the block at said respectively-corresponding plane of convergence.

8. A vehicular illumination system according to claim 1, configured such as
to maintain each first optical system of the array to remain spatially-invariably positioned and oriented with respect to an other first optical system of the array; and/or
to maintain each second optical system of the array to remain spatially-invariably positioned and oriented with respect to an other second optical system of the array; and/or
to maintain each third optical system of the array remain spatially-invariably positioned and oriented with respect to other third optical system of the array regardless of positioning and/or orientation of the first, second, and/or third optical systems with respect to one another.

9. A vehicular illumination system according to claim 8, wherein,
when said each first optical system of the array is maintained to remain spatially-invariably positioned and oriented with respect to the other first optical system of the array and/or when said each second optical system of the array is maintained to remain spatially-invariably positioned and oriented with respect to the other second optical system of the array,
a portion of the vehicular illumination system is axially limited by respectively-corresponding first optical systems and respectively-corresponding second optical systems is configured as a block of substantially optically uniform and optically transparent material that fills all space axially extending between input surfaces of the respectively-corresponding first optical systems and output surfaces of the respectively-corresponding second optical systems.

10. A vehicular illumination system according to claim 9, wherein either said block is defined by an optically transparent housing shell filled with a fluid or said block is defined by a substantially indivisible body of said optically uniform and optically transparent material that is a solid material.

11. A vehicular illumination system according to claim 9, wherein, when said portion of the vehicular illumination system includes an optical aperture formed in a respectively-corresponding plane of convergence of a chosen optical train, said optical aperture is configured to include a notch or groove defined by or in a bottom surface of said block in a plane that is transverse to a respectively-corresponding optical axis of said chosen optical train and/or said optical aperture is defined by a top surface of the block and the bottom surface of the block at said respectively-corresponding plane of convergence.

12. A vehicular illumination system according to claim 1,
wherein a first optical system of at least one optical train of the array of optical trains includes an optical surface having a central portion and a peripheral portion surrounding the central portion,
wherein the central portion of said surface is configured as a surface of a lens to receive first light from said source of light placed at the object location and to converge said first light towards the respectively-corresponding plane of convergence while the peripheral portion is configured as a surface of an optical reflector to receive second light from said source of light that has passed through an auxiliary portion of the optical surface and to converge said second light towards the respectively-corresponding plane of convergence.

13. A vehicular illumination system according to claim 12, wherein the auxiliary portion of the optical surface connects the central portion of the optical surface with the peripheral portion of the optical surface and/or wherein the optical surface is substantially spatially uninterrupted.

14. A vehicular illumination system according to claim 1, wherein the array of optical trains is configured such that third beams, produced by respectively-corresponding optical trains, substantially overlap at an illumination plane defined at a separation distance of at least 25 meters from the third optical system.

15. A vehicular illumination system according to claim 1, wherein
the array of optical trains is configured to form a light distribution in an illumination plane defined at a separation distance of at least 25 meters from the third optical system, wherein the light distribution satisfies requirements of a low beam profile defined by an FMVSS108 standard and/or by an R149e standard.

16. A vehicular illumination system according to claim 4, configured such as
to maintain each first optical system of the array to remain spatially-invariably positioned and oriented with respect to an other first optical system of the array; and/or
to maintain each second optical system of the array to remain spatially-invariably positioned and oriented with respect to an other second optical system of the array; and/or
to maintain each third optical system of the array remain spatially-invariably positioned and oriented with respect to other third optical system of the array regardless of positioning and/or orientation of the first, second, and/or third optical systems with respect to one another.

17. A vehicular illumination system according to claim 2,
wherein a first optical system of the first optical train is configured to form the respectively-corresponding first beam of light with such distribution of light in the respectively-corresponding plane of convergence that is not optically-conjugate to that at the respectively-corresponding object location;
and further comprising, in at least one of the first and second optical trains, an optical aperture formed in the respectively-corresponding plane of convergence and dimensioned such as to have a light distribution, generated by the at least one of the first and second optical trains, substantially not have luminous intensity above a horizon plane;
and
wherein each first optical system of the array is maintained to remain spatially-invariably positioned and oriented with respect to the other first optical system of the array and/or each second optical system of the array is maintained to remain spatially-invariably positioned and oriented with respect to the other second optical system of the array.

18. A method comprising:
with the vehicular illumination system according to claim 1, forming a light distribution in an illumination plane defined at a separation distance of at least 25 meters from the third optical system, wherein the light distribution satisfies requirements of a low beam profile defined by an FMVSS108 standard and/or by an R149e standard.

19. A method comprising:
with the vehicular illumination system according to claim 11, forming a light distribution in an illumination plane defined at a separation distance of at least 25 meters from the third optical system, wherein the light distribution satisfies requirements of a low beam profile defined by an FMVSS108 standard and/or by an R149e standard.

20. A method comprising:
with the vehicular illumination system according to claim 12, forming a light distribution in an illumination plane defined at a separation distance of at least 25 meters from the third optical system, wherein the light distribution satisfies requirements of a low beam profile defined by an FMVSS108 standard and/or by an R149e standard.
